(19) United States
(12) Patent Application Publication
(10) Pub. No.: US 2025/0315585 A1
(43) Pub. Date: Oct. 9, 2025

(54) MODIFYING A CURVILINEAR PATTERN IN A DESIGN LAYOUT OF A SEMICONDUCTOR SPECIMEN

(71) Applicant: Applied Materials Israel Ltd., Rehovot (IL)

(72) Inventors: Benjamin Christophe Jo VENITUCCI, Claix (FR); Jean-François Albert BOUGRON, Fontaine (FR)

(21) Appl. No.: 18/629,849

(22) Filed: Apr. 8, 2024

(51) Int. Cl. G06F 30/392; G06F 111/10; G06F 119/18

(52) U.S. Cl. CPC G06F 30/392; G06F 2111/10; G06F 2119/18

(57) ABSTRACT

There is provided a system and method of modifying a curvilinear pattern in a design layout of a semiconductor specimen. The method includes obtaining a basis spline (B-spline) curve contouring at least part of the curvilinear pattern, and a target displacement for a target point on the B-spline curve, the B-spline curve defined based on a set of control points; selecting, from the set of control points, one or more control points to be adjusted based on the location of the target point on the B-spline curve; and determining one or more displacements of the one or more control points based on a transition function, so as to obtain, upon moving the one or more control points according to the one or more displacements thereof, a modified B-spline curve comprising the target point moved according to the target displacement.

### TECHNICAL FIELD

The presently disclosed subject matter relates, in general, to the field of fabrication and examination of a semiconductor specimen, and more specifically, to pattern modification in a design layout of the specimen.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken.

A critical aspect of such evolution is the development of design layout formats, which serve as blueprints for the intricate patterns that constitute integrated circuits (ICs) on semiconductor wafers. Historically, the Graphic Data System II (GDSII) format dominated the industry as a standard for representing geometric shapes and connectivity in IC designs, utilizing polygons to delineate the various features of the semiconductor devices.

As the semiconductor industry progressed towards more advanced technology nodes, the limitations of polygon-based formats like GDSII became increasingly apparent. These limitations included large file sizes and the inability to accurately represent the complex geometries required by advanced manufacturing processes. To address these challenges, the Open Artwork System Interchange Standard (OASIS) format was introduced, offering superior compaction, enhanced data structure for faster access, and support for a broader range of geometric shapes. Despite these improvements, OASIS, remaining fundamentally polygon-based, still faced challenges in precisely representing curvilinear features critical for nanoscale device fabrication.

The advent of curvilinear design layout formats marked a significant leap forward, enabling the direct representation of curves, such as Explicit Bezier curves, Implicit Bezier curves, and B-Spline curves, rather than approximating them with straight-line segments. This evolution was largely driven by the need for more precise and efficient lithography processes, including those enabled by Inverse Lithography Technology (ILT), which inherently generates curvilinear patterns. Although curvilinear formats can be considered an extension or evolution of existing formats like OASIS, they are distinct in their ability to natively support complex curvilinear geometries, offering a new paradigm in design layout representation.

Curvilinear formats, by facilitating the accurate depiction of curves, present several advantages over traditional polygon-based formats. The ability of modifying curvilinear patterns in a design layout is essential for streamlining the adaptation of design layouts to meet the stringent requirements of various aspects of next-generation semiconductor fabrication processes.

### SUMMARY

In accordance with certain aspects of the presently disclosed subject matter, there is provided a computerized system of modifying a curvilinear pattern in a design layout of a semiconductor specimen, the system comprising a processing circuitry configured to obtain a basis spline (B-spline) curve contouring at least part of the curvilinear pattern, and a target displacement for a target point on the B-spline curve, the B-spline curve defined based on a set of control points; select, from the set of control points, one or more control points to be adjusted based on the location of the target point on the B-spline curve; and determine one or more displacements of the one or more control points based on a transition function, so as to obtain, upon moving the one or more control points according to the one or more displacements thereof, a modified B-spline curve comprising the target point moved according to the target displacement.

In addition to the above features, the system according to this aspect of the presently disclosed subject matter can comprise one or more of features (i) to (xi) listed below, in any desired combination or permutation which is technically possible:
(i). The B-spline curve can be defined by a curve function represented as a combination of the set of control points multiplied by a set of basis functions respectively associated therewith.
(ii). A basis function of a given control point can be a piece-wise polynomial function of a variable representing a location on the B-spline curve.
(iii). The one or more control points can be selected based on values of the set of basis functions at the location of the target point on the B-spline curve.
(iv). The transition function can be defined to represent, for each given control point of the one or more control points, a respective proportional relationship between a respective displacement of the given control point and the target displacement.
(v). The proportional relationship for a given control point can be defined in a form of a normalized basis function of the given control point.
(vi). The basis function can be normalized based on a power parameter configurable to tune a range of displacement of curve points that are moved due to modification of the B-spline curve.
(vii). The basis function can be normalized by a correction function such that a maximum displacement of curve points on the B-spline curve is the target displacement of the target point.
(viii). The transition function can be defined to enable consistency of modified B-spline curves resulting from variations of the location of the target point on the B-spline curve.
(ix). The transition function can be defined to enable the modified B-spline curve to preserve geometric properties of continuity and smoothness.
(x). The modified B-spline curve can form a part of a modified design layout of the semiconductor specimen. The modified design layout is usable in a lithography process for compensating lithography process errors.
(xi). The modified B-spline curve can form at least part of a coarse contour of the curvilinear pattern in a modified design layout of the semiconductor specimen.

The coarse contour is usable as a reference contour for identifying an actual contour in an examination image acquired for a specimen manufactured using the modified design layout.

In accordance with other aspects of the presently disclosed subject matter, there is provided a computerized method of modifying a curvilinear pattern in a design layout of a semiconductor specimen, the method comprising: obtaining a basis spline (B-spline) curve contouring at least part of the curvilinear pattern, and a target displacement for a target point on the B-spline curve, the B-spline curve defined based on a set of control points; selecting, from the set of control points, one or more control points to be adjusted based on the location of the target point on the B-spline curve; and determining one or more displacements of the one or more control points based on a transition function, so as to obtain, upon moving the one or more control points according to the one or more displacements thereof, a modified B-spline curve comprising the target point moved according to the target displacement.

These aspects of the disclosed subject matter can comprise one or more of features (i) to (xi) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of modifying a curvilinear pattern in a design layout of a semiconductor specimen, the method comprising: obtaining a basis spline (B-spline) curve contouring at least part of the curvilinear pattern, and a target displacement for a target point on the B-spline curve, the B-spline curve defined based on a set of control points; selecting, from the set of control points, one or more control points to be adjusted based on the location of the target point on the B-spline curve; and determining one or more displacements of the one or more control points based on a transition function, so as to obtain, upon moving the one or more control points according to the one or more displacements thereof, a modified B-spline curve comprising the target point moved according to the target displacement.

This aspect of the disclosed subject matter can comprise one or more of features (i) to (xi) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of a fabrication system for a semiconductor specimen in accordance with certain embodiments of the presently disclosed subject matter.

FIG. 2 illustrates a generalized flowchart of modifying a curvilinear pattern in a design layout of a semiconductor specimen in accordance with certain embodiments of the presently disclosed subject matter.

FIG. 3 illustrates a generalized flowchart of defining the transition function in accordance with certain embodiments of the presently disclosed subject matter.

FIG. 4 illustrates an exemplary B-spline curve with associated basis functions in accordance with certain embodiments of the presently disclosed subject matter.

FIG. 5 illustrates an example of modifying a target point on a B-spline curve in accordance with certain embodiments of the presently disclosed subject matter.

FIG. 6 illustrates an exemplary representation of basis functions and proportional relationships derived therefrom in accordance with certain embodiments of the presently disclosed subject matter.

FIG. 7 and FIG. 8 illustrate two examples of inconsistency of modified curves resulting from variations of the target point's locations in accordance with certain embodiments of the presently disclosed subject matter.

FIG. 9 illustrates an example of consistency of modified curves resulting from variations of the target point's locations in accordance with certain embodiments of the presently disclosed subject matter.

FIG. 10 illustrates an example of curve point displacements of a B-spline curve in cases of different power parameters in accordance with certain embodiments of the presently disclosed subject matter.

FIG. 11 illustrates an example of curve point displacements of a B-spline curve with or without the normalization by a correction function in accordance with certain embodiments of the presently disclosed subject matter.

### DETAILED DESCRIPTION OF EMBODIMENTS

Optical Proximity Correction (OPC) technology has been evolving as lithography technology advances in order to achieve higher resolution at new technology nodes. One approach for further extending lithography resolution is Inverse Lithography Technology (ILT). ILT is a design methodology used to optimize photomask patterns to improve the printability of fine features on semiconductor wafers. Unlike traditional lithography approaches that work directly from the geometric shapes of the design layout, ILT applies an inverse lithography model to a target design layout based on the desired outcome on the wafer, in order to determine which structure should be present on the mask. This allows for the creation of photomask patterns that can more accurately produce the intended geometries on the wafer surface, especially as feature sizes decrease to the nanometer scale.

Curvilinear patterns/shapes are created by ILT to compensate lithography process variations. Such patterns have introduced new complexities and challenges for adaptation. A curvilinear shape refers to a shape having a contour made of sections that are either polygonal or curved. In other words, a design layout in curvilinear format may be a combination of polygon and/or curve formats. A curvilinear shape, when being represented as polygons that contain lots of vertices, leads to an increase of the layout file size. For addressing this issue, an extended OASIS format was developed to support curves. The new format allows representation of curvilinear shapes by using curve descriptions, supporting curves such as Explicit Bezier, B-Spline, and Implicit Bezier curves, etc. Depending on the original design intent of a given shape, a curve representation of the shape can be much more compact than a polygonal representation. By way of example, using curve representation of a contour can enable a compaction of file size by a factor of ten as compared to polygon representation of the same contour, via more efficient geometric representation.

Additional advantages of the new curvilinear formats include enhanced precision in manufacturing processes by closely matching the intended design geometries, and improved manufacturability of advanced semiconductor devices. The precision afforded by curvilinear formats is particularly crucial for advanced lithography techniques, such as electron-beam lithography and extreme ultraviolet (EUV) lithography, where the exact control of complex shapes can significantly impact device performance and yield.

Curvilinear formats can be used in various process steps, including design, OPC, mask process correction (MPC), and mask writing, etc. In particular, OPC and MPC involves shape manipulations of a design pattern, such as, e.g., sizing operations, which generally refer to local modification of the pattern according to a target transformation, without changing its mathematical properties.

By way of example, such modification is of particular importance in the OPC process. OPC is designed to adjust the design layout of semiconductor devices to counteract the distortions and proximity effects that occur during the photolithography process. The modification of design patterns is crucial for ensuring that the critical dimensions of device features are accurately reproduced on the wafer.

The inherent complexity of curvilinear formats has introduced new challenges in the sizing process, as compared to sizing on polygons. Polygonal representations are inherently simpler, composed of straight-line segments and vertices. Sizing operations on polygons typically involve straightforward offsetting of edges or vertices. In comparison, sizing operations on curves, such as moving an arbitrary point on a curve, would introduce challenges due to the mathematical properties of the curve and the implications for the curve's overall shape and continuity.

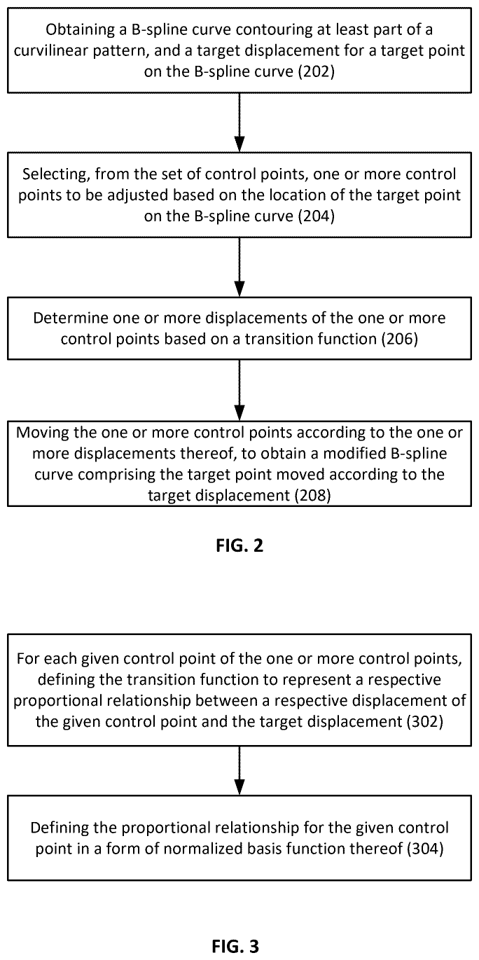

By way of example, moving a point on a B-spline curve with a given displacement does not straightforwardly map to adjustments in its control points, as control points for a B-spline curve in general do not lie on the curve itself. Achieving a specific displacement for a curve point involves complex calculations to determine how the underlying control points should be adjusted, as a displacement of a curve point does not correspond to the same displacement of the underlying control points. The modification should also take into consideration the resulting curve's geometric properties, such as the ability to create continuous/smooth curves without abrupt changes in direction. Potential complexity and the complications of such modification are further detailed below with reference to FIG. 2.

Accordingly, certain embodiments of the presently disclosed subject matter propose a pattern modification system, which addresses one or more of the issues described above. The present disclosure proposes to modify a B-spline curve in a design layout of a semiconductor specimen, specifically, to move a target point on the curve in accordance with a target displacement. This is done by selecting a set of control points to be adjusted, and determining respective displacements of the selected control points based on a specifically defined transition function, as will be detailed below.

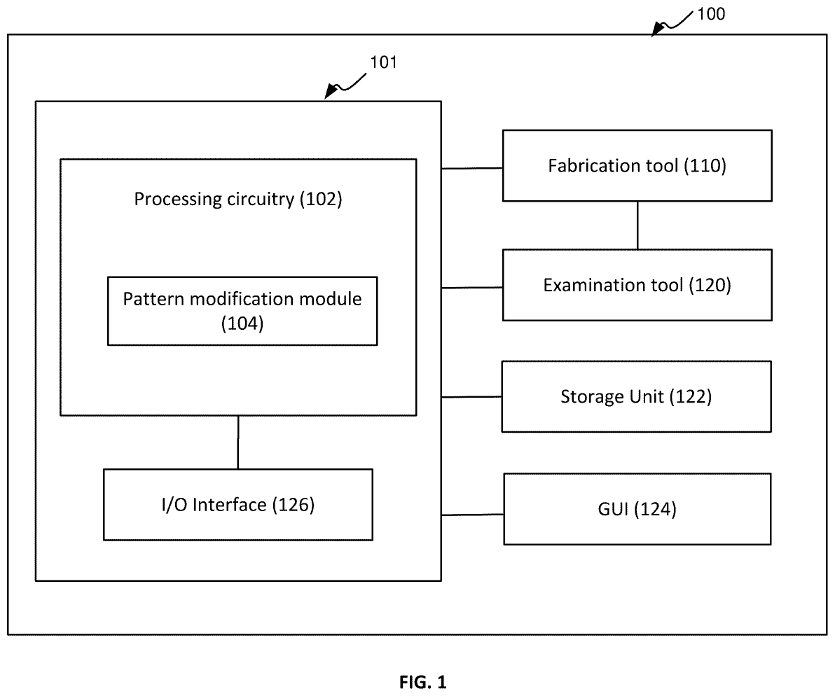

Bearing this in mind, attention is drawn to FIG. 1 illustrating a functional block diagram of a fabrication system for a semiconductor specimen in accordance with certain embodiments of the presently disclosed subject matter.

The fabrication system 100 illustrated in FIG. 1 can be used for manufacturing a semiconductor specimen (e.g., a photomask or a wafer, or parts thereof) using a fabrication tool 110 comprised therein. In some embodiments, the semiconductor specimen can refer to a photomask (also referred to as a mask or a reticle) used to manufacture semiconductor devices in a photolithography process. In such cases, system 100 is a mask writing system configured to create a photomask usable in lithography to transfer patterns onto semiconductor wafers. The fabrication tool 110 in such a system refers to a mask writing tool (also known as mask writers or photomask writers) for manufacturing a mask based on its design intent. Mask writing tools typically offer high precision and resolution to accurately transfer the intricate designs of integrated circuits onto masks.

Various mask writing tools can be used for manufacturing a photomask, such as, e.g., electron beam (E-beam) writers which use a focused beam of electrons to draw the circuit patterns directly onto the mask's surface that is coated with an electron-sensitive resist, or optical writers such as laser writers that use a laser beam to expose the photoresist on the mask, etc.

In some embodiments, the semiconductor specimen can refer to a semiconductor wafer manufactured in a lithography process using a photomask. In such cases, system 100 can refer to a lithography system configured to transfer the patterns from the mask onto the silicon wafer. Such tools typically use light or other types of radiation to project the mask's image onto the photoresist-coated wafer, creating the patterns needed to build the semiconductor devices. The fabrication tool 110 in such a system refers to a lithography tool (also known as steppers or scanners) configured to project an image of the circuit pattern of a photomask to be duplicated onto a wafer (e.g., by employing various stepping, scanning and/or imaging techniques to produce or replicate the pattern on the wafer).

Various lithography tools can be used for manufacturing a wafer, such as, e.g., optical lithography tools that use ultraviolet (UV) light to expose the photoresist on the wafer, or extreme ultraviolet (EUV) lithography tools that use extremely short-wavelength light (e.g., around 13.5 nm) to achieve much higher resolution than with DUV systems, etc.

Without limiting the scope of the disclosure in any way, it should also be noted that the fabrication tool 110 can be implemented as machines of various types such as optical machines, electron beam machines (e.g., a Scanning Electron Microscope (SEM), etc.), and so on, with different resolution capabilities. The present disclosure is not limited to any specific type of fabrication tools and/or the resulting resolutions thereof.

According to certain embodiments of the presently disclosed subject matter, the fabrication system 100 comprises a computer-based system 101 operatively connected to the fabrication tool 110, and capable of modifying a curvilinear pattern (specifically, a B-spline curve thereof) in a design layout of a semiconductor specimen. System 101 is also referred to as a pattern modification system.

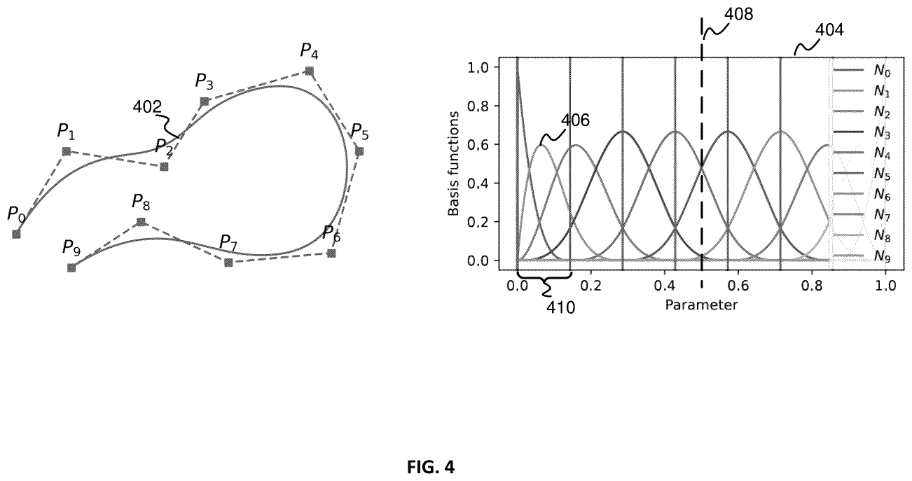

System 101 includes a processing circuitry 102 operatively connected to a hardware-based I/O interface 126 and configured to provide processing necessary for operating the system, as further detailed with reference to FIGS. 2-3. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

According to certain embodiments, one or more functional modules comprised in processing circuitry 102 can include a pattern modification module 104. Specifically, the processing circuitry 102 can be configured to obtain a basis spline (B-spline) curve contouring at least part of the curvilinear pattern in the design layout, and a target displacement for a target point on the B-spline curve. The B-spline curve is defined based on a set of control points. The pattern modification module 104 can be configured to select, from the set of control points, one or more control points to be adjusted based on the location of the target point on the B-spline curve, and determine one or more displacements of the one or more control points based on a transition function, so as to obtain, upon moving the one or more control points according to the one or more displacements thereof, a modified B-spline curve comprising the target point moved according to the target displacement.

In some embodiments, the pattern modification module 104 can be implemented as part of an OPC module (not illustrated in FIG. 1) configured to adjust the design layout of a semiconductor specimen to counteract/compensate any distortions/variations/errors that occur during a lithography process. Pattern modification, such as modifying curve points on a curvilinear pattern, is integral to OPC, where the goal is to tweak the design layout, such that, once processed through lithography, the printed patterns on the wafer are as close as possible to the original design. This can include adjusting, for optical proximity effects, etch bias, and other process variations.

OPC, and the pattern modification thereof, are primarily part of the design process and/or mask preparation process. OPC adjustments, including the pattern modifications on the curves, are made before the mask is manufactured, ensuring that the patterns on the mask will print as intended on the wafer. The ability to modify curve points in OPC allows for fine-tuning the design to achieve optimal pattern fidelity and performance characteristics. The modified pattern by OPC (e.g., the modified B-spline curve) can be provided to the mask writing tool to be used for generating the photomask.

In some embodiments, the pattern modification module 104 can be part of an MPC module (not illustrated in FIG. 1). MPC is similar to OPC, but is rather specifically focused on correcting mask patterns to account for mask manufacturing constraints and errors that can occur during the mask manufacturing itself. The objective of MPC is to ensure that the physical mask produced accurately reflects the corrected design layout (post-OPC). This involves adjusting for factors like etch loading effects, electron scattering in electron beam lithography, and other mask-specific process variations. Pattern modification can be used in MPC for counteracting these effects during the mask manufacturing process.

Once the mask is prepared based on the corrected/modified pattern, it is used in the lithography process (by a lithography tool) to accurately print patterns onto the semiconductor wafers which closely match the original design specifications.

In some embodiments, system 100 can further comprise one or more examination tools 120 configured to perform various examination operations on a semiconductor specimen (or part thereof) manufactured by the fabrication tool 110. The examination operations can include defect-related examination (e.g., defect detection, defect review, and defect classification, etc.), and/or metrology-related examination (e.g., critical dimension (CD) measurements, etc.) at different processing steps/layers during the manufacturing process to monitor and control the process. The examination operations can be performed a multiplicity of times, for example after certain processing steps, and/or after the manufacturing of certain layers, or the like.

The one or more examination tools can be configured to scan a specimen and capture images thereof to be further processed for various examination applications. The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Similarly, it should also be noted that the examination tools can be implemented as inspection machines of various types, such as optical inspection machines, electron beam inspection machines, and so on.

In some cases, at least one of the examination tools 120 has metrology capabilities and can be configured to capture images and perform metrology operations on the captured images. Such an examination tool is also referred to as a metrology tool, such as, e.g., a critical dimension scanning electron microscope (CD-SEM) used to measure critical dimensions of structural features in the images. In such cases, the modified pattern (e.g., the modified B-spline curve) can be possibly used as part of reference contour of the curvilinear pattern, for purpose of identifying an actual contour in an examination image of a specimen manufactured using the modified design layout, such as, e.g., in the process of image segmentation in SEM images. The reference contour can be used to be compared with the actual contour for different purposes, such as, e.g., obtaining measurements in metrology operations, and/or defect-related operations during runtime examination of the specimen.

Additionally or alternatively, in some cases, the one or more examination tools 120 can include one or more inspection tools configured to scan a specimen (e.g., an entire wafer, or an entire die) to capture inspection images (typically, at a relatively high-speed and/or low-resolution) for detection of potential defects (i.e., defect candidates), and/or one or more review tools configured to capture review images of at least some of the defect candidates detected by the inspection tools for ascertaining whether a defect candidate is indeed a defect of interest (DOI). In such cases, the modified pattern in the design layout of the specimen can be used as a reference for defect detection and/or defect review.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the functionalities/operations as described above can be performed by a specific processor, or by respective processors (or processor combinations) in the processing circuitry 102. The present disclosure should not be limited to being construed as one single processor always performing all the operations of the processing circuitry.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store a design layout of a semiconductor specimen, and/or images of the manufactured specimen as produced by the examination tool 120, etc., as described above. Accordingly, the different types of input data as required can be retrieved from the storage unit 122 and provided to the processing circuitry 102 for further processing. The output of the system 101, such as, e.g., the modified curve or design layout, etc., can be sent to the storage unit 122 to be stored, or sent to the fabrication tool 110 for manufacturing the specimen.

In some embodiments, system 100 can optionally comprise a computer-based Graphical User Interface (GUI) 124 which is configured to enable user-specified inputs related to system 101. For instance, the user can be presented with a visual representation of the design layout, the curvilinear pattern or the B-spline curve thereof (for example, by a display forming part of GUI 124), etc. The user may be provided, through the GUI, with options of defining certain operation parameters. The user may also view the operation results or intermediate processing results, such as, e.g., the modified curve or design layout, etc., on the GUI.

In some cases, system 101 can be further configured to send, via I/O interface 126, the operation results to the fabrication tool 110 and/or the examination tool 120 for further processing. In some cases, system 101 can be further configured to send the results to external systems, such as, e.g., Yield Management System (YMS) of a fabrication plant (Fab). A yield management system (YMS) in the context of semiconductor manufacturing is a data management, analysis, and tool system that collects data from the fab, especially during manufacturing ramp ups, and helps engineers find ways to improve yield. YMS helps semiconductor manufacturers and fabs manage high volumes of production analysis with fewer engineers. These systems analyze the yield data and generate reports. YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized fabrication system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that in some embodiments at least some of the fabrication tool 110, the examination tool 120, the storage unit 122 and/or GUI 124 can be external to system 100 and operate in data communication with systems 100 and 101 via I/O interface 126. System 101 can be implemented as stand-alone computer(s) to be used in conjunction with the tools. Alternatively, the respective functions of the system 101 can, at least partly, be integrated with the fabrication tool 110 and/or the examination tool 120, thereby facilitating and enhancing the functionalities of the examination tools in examination-related processes.

It should be noted that the examination system illustrated in FIG. 1 can be implemented in a distributed computing environment, in which one or more of the aforementioned components and functional modules shown in FIG. 1 can be distributed over several local and/or remote devices. By way of example, the fabrication tool 110, examination tool 120 and the system 101 can be located at the same entity (in some cases hosted by the same device), or distributed over different entities, depending on specific system configurations and implementation needs.

In some examples, certain components utilize a cloud implementation, e.g., are implemented in a private or public cloud. Communication between the various components of the fabrication system, in cases where they are not located entirely in one location or in one physical entity, can be realized by any signaling system or communication components, modules, protocols, software languages, and drive signals, and can be wired and/or wireless, as appropriate.

While not necessarily so, the process of operations of systems 101 and 100 can correspond to some or all of the stages of the methods described with respect to FIGS. 2-3. Likewise, the methods described with respect to FIGS. 2-3 and their possible implementations can be implemented by systems 101 and 100. It is therefore noted that embodiments discussed in relation to the methods described with respect to FIGS. 2-3 can also be implemented, mutatis mutandis as various embodiments of the systems 101 and 100, and vice versa.

Referring to FIG. 2, there is illustrated a generalized flowchart of modifying a curvilinear pattern in a design layout of a semiconductor specimen in accordance with certain embodiments of the presently disclosed subject matter.

As described above, the semiconductor specimen can refer to a photomask usable to manufacture semiconductor devices in a photolithography process, or a semiconductor wafer manufactured using a photomask. A design layout refers to a detailed representation of original intended geometric patterns that need to be transferred onto a semiconductor wafer during the manufacturing process. Such layout specifies the shapes, sizes, and positions of the various features that make up the integrated circuits (ICs) or other devices on the wafer. It serves as a blueprint for the fabrication process, guiding the steps of photolithography, etching, doping, and other processes required to build the semiconductor devices.

In particular, a design layout, when referring to a photomask, defines the opaque and transparent areas of the mask that will modulate light during the photolithography process. The layout directly corresponds to the circuit patterns that are to be transferred onto the wafer, with the opaque regions blocking light and the transparent regions allowing light through, thereby transferring the pattern onto the wafer coated with photoresist.

A design layout can be created and stored in various types and formats, such as, e.g., GDSII, OASIS, as well as extended versions thereof. For instance, an extended OASIS format of design layout is developed to support curve representation of curvilinear shapes, such as, e.g., Explicit Bezier curves, Implicit Bezier curves, and B-Spline curves, etc. Electronic Design Automation (EDA) tools can be used to design and create design layouts in various formats, such as GDSII or OASIS, using Computer-Aided Design (CAD).

The curves as mentioned above are referred to as parametric curves, which, in addition to their geometrical properties, can be represented and described through a mathematical function t->C(t), where t is an interval and C(t) belongs to a certain set of points. The function C(t) is also referred to as a parameterization of the curve. A curve may have several parameterizations which are equivalent from a geometrical point of view.

Certain embodiments of the present disclosure specifically relate to a design layout that comprises a specific type of curves—a basis spline (B-spline) curve, and the manipulation, in particular the modification thereof. A modification, in the context of a curvilinear pattern, generally refers to locally modify a parametric curve in a way that preserves its mathematical properties. Certain embodiments of the present disclosure relate to manipulating/modifying the curve to move a target point on the curve to a new location in accordance with a target displacement.

For a given B-spline curve, such target displacement for a given curve point can be achieved via various ways of manipulation of the curve. By way of example, it is possible to adjust the position of a single control point in an attempt to move a specific point on the B-spline curve to a new target location. However, moving one control point often cannot precisely achieve the desired target displacement due to the influence of control points and the weighted nature of their contribution to the curve's shape through the basis functions. Such a method may also introduce unwanted changes to the curve's shape, and potentially affect the curve shape drastically (e.g., with abrupt changes) in cases of slight changes of the location of on-curve points.

Alternatively, it is possible to move multiple control points for realizing such displacement, which introduces several layers of complexity and complications in terms of the curve's mathematical and geometric properties. For instance, it may be needed to identify which control points influence (or most significantly influence) the position of the target point on the curve, as each control point affects the curve in a region determined by its associated basis functions. In addition, it requires sophisticated calculation of the appropriate magnitude and direction of adjustments for each selected control point. Since B-spline curves are defined as a weighted sum of control points, each adjustment needs to be weighted according to the basis function values at the target curve point's parameter value. The need to balance multiple adjustments simultaneously, while ensuring that the cumulative effect results in the exact desired displacement of the curve point, is not trivial. Moreover, adjustments made to move a specific point may inadvertently introduce sharp transitions or significantly alter the curve's local curvature, which is undesired.

Due to the complexity, various optimization methods have been proposed to iteratively adjust control points and converge on the desired target displacement. This often involves minimizing a cost function that quantifies the deviation from the target displacement and possibly other design constraints. Such optimization processes are often computationally intensive, and sensitive to initial conditions and parameter settings, potentially leading to convergence on local minima that do not represent the best possible solution.

Accordingly, certain embodiments of the present disclosure propose a unique way of modifying the curve to move a target point in accordance with a target displacement, as described below.

Specifically, in some embodiments, a curvilinear pattern/shape in a design layout of a semiconductor specimen may comprise B-spline curve contouring at least part of the pattern. In some cases, the curvilinear pattern may be contoured solely with one or more B-spline curves, while in some other cases, the curvilinear pattern may be contoured partially with polygonal representation (e.g., as a combination of small straight segments) in addition to the B-spline curve.

The basis spline (B-spline) curve contouring at least part of the curvilinear pattern can be obtained (202) (e.g., by the pattern modification module 104), together with a target displacement for a target point on the B-spline curve. The B-spline curve can be defined based on a set of control points. The target displacement can include both the direction and magnitude of the displacement for the target point to be moved, as a goal.

A B-spline curve can be defined based on a set of control points. Specifically, the B-spline curve can be defined mathematically by a curve function represented as a combination of a set of control points multiplied by a set of basis functions respectively associated therewith. The curve can be constructed by linearly combining control points Pᵢ with B-spline basis functions N_{i,p}(u), where p denotes the degree of the curve (e.g., linear, quadratic, cubic, etc.), i indexes the control points, and u is a parameter/variable that varies, typically between 0 and 1, along the length of the curve. By way of example, a B-spline curve can be represented in the following general form:

$$C ( u ) = {\sum }_{i = 0}^{n} {N}_{i , p} ( u ) {P}_{i} , u ∈ [ 0 , 1 ] \qquad ( 1 )$$

where n is the number of control points minus one, Pᵢ are the control points, and N_{i,p}(u) are the B-spline basis functions of degree p associated with each control point.

Control points refer to a set of ordered points in a geometric space that determine the overall geometry of the B-spline curve. These points are not necessarily on the curve itself. The collection of control points is often referred to as the “control polygon” as connecting them sequentially forms a polygonal approximation of the curve. The curve's shape can be adjusted by moving one or more of the control points. The influence of a particular control point on the curve's shape is localized around the region of the curve associated with that point, due to the properties of the B-spline basis functions.

Basis functions refer to mathematical functions associated with each control point that determine how the control points influence the shape of the B-spline curve over the parameter domain. The basis functions for B-splines are defined over a variable parameter u (which in some cases can be represented by other symbols such as t), which typically ranges from 0 to 1.

Specifically, with respect to the above general form representation of B-spline curve in equation (1), each control point Pᵢ is associated with a basis function N_{i,p}(u), where p is the degree of the curve (e.g., linear, quadratic, cubic). For instance, a basis function N_{i,p}(u) of a given control point Pᵢ can be represented as a piece-wise polynomial function of a variable u representing a location on the B-spline curve. The curve can be regarded as formed by taking a weighted sum of the control points, with the weights at any point on the curve given by the values of the basis functions at that point. The shape and smoothness of the curve can be directly influenced by the properties of these basis functions.

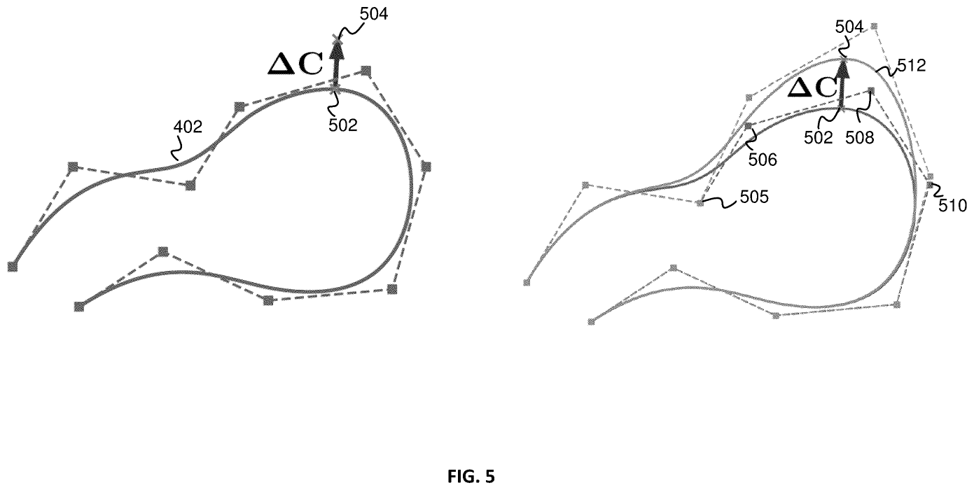

FIG. 4 illustrates an exemplary B-spline curve with associated basis functions in accordance with certain embodiments of the presently disclosed subject matter.

The B-spline curve 402 is exemplified as a curve with degree 3 (i.e., a cubic curve, where p=3). It is defined based on a set of ten control points P₀-P₉. In the present example, the control points are not on the curve 402 itself. The ten control points, when connecting sequentially (illustrated by dashed lines), form a “control polygon” that represents a polygonal approximation of the curve. P₀ and P₉ are sometimes referred to as the end points of the curve.

Graph 404 shows a representation of basis functions of B-spline curve 402 in an x-y coordinate, where the x axis represents the value of the parameter/variable u, and the y axis represents the values of the basis functions. The B-spline curve is defined over the parameter (e.g., u) domain, typically divided by a non-decreasing sequence of values called the “knot vector.” The knot vector is a collection of parameter values that partition the domain into intervals or “spans”. 410 denotes such an interval/span. The span index refers to the position within the knot vector that identifies the start of a specific interval over which a particular set of basis functions is non-zero.

As illustrated in graph 404, N₀-N₉ represent respective basis functions of P₀-P₉. Each basis function is represented as a piece-wise polynomial function of the variable/parameter u, representing how a corresponding control point influences the shape of the B-spline curve over a certain range/interval of the variable u domain.

In other words, each basis function is non-zero only over a limited range of the variable domain. This property underlies the local control characteristic of B-splines, where moving a control point affects only a portion of the curve. By way of example, basis function N₁ 406 is non-zero over a range of approximately [0-0.3] of the variable u, indicating that any adjustment of control point P₁ only impacts the shape of the curve within this range.

On the other hand, it can be derived that a given point on the curve can be only affected by a subset of the control points. Specifically, for a given point on the curve with a given value of variable u, the control points that affect the given point can be determined as those control points whose basis functions are non-zero at the given value of u. For instance, for a specific point on the curve whose location corresponds to a value 408 of u, as illustrated in 404, the control points that impact this point would be P₃, P₄, P₅ and P₆, whose basis functions have a non-zero value at the value 408 of u (i.e., the basis functions that intersect with the dashed line 408). As a matter of fact, a given point on the curve will be affected by at most p+1 control points, depending on the shape of basis functions.

Therefore, in cases where a given point on a B-spline curve needs to be moved in accordance with a given displacement, it is necessary to first determine the subset of control points that should be adjusted in order to realize such modification.

Continuing with the description of FIG. 2, a subset of control points (e.g., one or more control points) to be adjusted can be selected (204) from the set of control points, based on the location of the target point on the B-spline curve.

In the example of FIG. 4, when the target point to be moved is the point at a corresponding parameter value 408 of u, a subset of four control points N₃, N₄, N₅ and N₆ can be selected, based on the basis function representation and the location of the target point on the curve (defined by the corresponding u value), as described above.

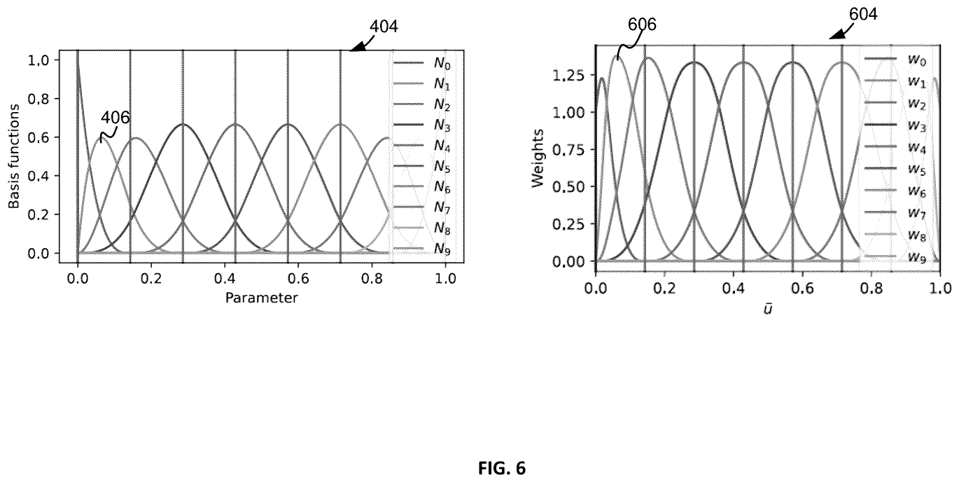

FIG. 5 illustrates an example of modifying a target point on a B-spline curve in accordance with certain embodiments of the presently disclosed subject matter.

Continuing with the exemplary B-spline curve 402, a target point 502 on the curve 402 is to be moved to a target location 504 in accordance with a target displacement ΔC (illustrated by an arrow). As a result, four control points 505, 506, 508, and 510 (corresponding to P₂, P₃, P₄ and P₅) are selected as described above, based on values of the set of basis functions 404 at the location of the target point on the B-spline curve. The selected control points are moved in accordance with respective displacements, so as to result in a modified curve 512 where the target point 502 is moved to its target location 504.

As described above, it is complicated and non-trivial to derive the appropriate magnitude and direction of adjustments for each selected control point (e.g., the specific displacement for each of the control points 505, 506, 508, and 510 in the above example), so as to balance the multiple adjustments simultaneously, while ensuring that the cumulative effect results in the exact desired displacement of the target point, as well as preservation of geometrical properties of the curve. There is now described a solution for deriving specific displacements for selected control points in accordance with certain embodiments of the presently disclosed subject matter.

Continuing with the description of FIG. 2, one or more displacements of the one or more selected control points can be determined (206) based on a transition function. These displacements are determined such that upon moving the one or more control points accordingly, a modified B-spline curve can be obtained (208), comprising the target point moved according to the target displacement.

A transition function, also referred to as a displacement function, is defined for the purpose of deriving the specific displacement for each selected control point. One assumption taken in the present disclosure is that all selected control points are presumed to be moved in the same direction as the direction of the target displacement of the target point. Such an assumption is valid and reasonable, as moving all selected control points in a similar direction as the target displacement may assist to result in a natural and smooth appearance of the resulting curve. This assumption can also reduce the degree of freedom of the problem to be solved, as instead of dealing with 2D displacement for each control point, the goal under such assumption becomes 1D displacement for each control point along the direction of the target displacement.

The goal is to move a target point on the curve (also referred to as an on-curve point, or a curve point) at a given variable/parameter value ū by a target displacement ΔC. As described above, at most p+1 control points may impact the curve at the given parameter value. The respective displacements for these control points can be referred to as ΔPᵢ. The respective displacements of the selected control points should meet the below condition, based on the general representation of B-spline curve defined in above equation (1):

$${\sum }_{i = k - p}^{k} {N}_{i , p} ( \overline{u} ) Δ {P}_{i} = Δ C \qquad ( 2 )$$

where k is the span index in which ū lies on, and p the degree of the B-spline curve.

A first assumption for deriving the transition function in the present disclosure is that the specific displacements of the selected control points can be presumed to be proportional to the target displacement of the target point. Such proportional relationship can be represented by below equation (3):

$$Δ {P}_{i} = {w}_{i} Δ C \qquad ( 3 )$$

where wᵢ represents the proportion between a respective displacement of a given control point i and the target displacement of the target point.

The transition function can thus be defined to represent, for each given control point of the one or more control points, a respective proportional relationship between a respective displacement of the given control point and the target displacement, as illustrated in equation (3). For purpose of deriving the transition function, it is therefore needed to seek the value of the proportion wᵢ.

When integrating equation (3) into the condition of equation (2), below equation (4) can be obtained:

$${\sum }_{i = k - p}^{k} {N}_{i , p} ( \overline{u} ) {w}_{i} = 1 \qquad ( 4 )$$

There are various ways of deriving the values for wᵢ based on equation (4). However, not every derived wᵢ can properly preserve the geometrical properties of the resulting B-spline curve after the manipulation, such as continuity, smoothness, as well as robustness of the modification, i.e., the consistency/closeness of modified curves resulting from variations of locations of the target point, as detailed below.

Continuity in B-spline curves refers to the mathematical property describing how components of the curve join together without breaks. It can be quantified by the degree of derivative that is continuous across the boundary of curve components. There are a few different levels of continuity. For instance, C⁰ Continuity implies that the curve is simply connected without any gaps between components. There is no sudden jump from one point on the curve to another. C¹ Continuity ensures that the first derivative (e.g., tangent vector) is continuous across component joins, which means the curve does not have sharp corners, and the direction changes smoothly at the joins. C² Continuity indicates that the second derivative (related to geometrical curvature) is continuous, ensuring that the rate of curvature change is smooth across component joins. This level of continuity often characterizes a visually smooth transition from one curve component to another.

Smoothness, while related to continuity, relates more to the curve's visual and geometric quality. It refers to how gradually or smoothly the curve transitions in shape and direction. A curve can be mathematically continuous, but may not appear visually smooth, if, for example, there are abrupt changes in curvature (even if those changes are continuous). Smoothness can be regarded as a perceptual or qualitative assessment of the curve's properties, considering factors such as how evenly the curve bends or twists, the absence of abrupt direction changes that are visually perceptible, and the uniformity of the curve's progression, etc.

As continuity is strictly a mathematical property defined by the absence of breaks and the behavior of derivatives across segments, adjusting control points to change the curve's shape will most likely maintain the mathematical continuity defined by the curve's degree. However, the perceived smoothness (e.g., geometric smoothness) can be possibly affected by how these adjustments are made. For instance, moving control points with drastic displacements may introduce unevenness in curvature that affects the visual smoothness, despite the curve's continuous mathematical properties.

In addition to the above concerns, the present disclosure has identified another important issue that may occur during such modification, related to the robustness of the modification process. Robustness, in the present context, pertains to the stability and reliability of the curve manipulation process in the face of minor variations in input parameters, such as variations in the exact location of the target point on the curve. When attempting to move a target point on a B-spline curve to counteract distortions in the photolithography process, the location of the target point is determined by certain preceding computational processes. Due to the inherent inaccuracies or variations in these computations, the exact target location might slightly vary between computations. If these variations result in selecting different control points for adjustment, the minor differences in target location can lead to significantly different outcomes for the adjusted curve. For instance, if two target points are close, but fall in different spans, they might be influenced by different sets of control points. Slight variations in their locations can thus lead to adjustments in different control points, causing a noticeable difference in the resulting curve shapes.

Robustness, when related to the process of adjusting B-spline curves, refers to the ability of the process to produce consistent and predictable outcomes despite small variations or computational inaccuracies in input data. A robust process would yield similar shapes for the resulting curves, even if the specified target points for movement are slightly different, provided those points are intended to correct similar distortions. On the other hand, a less robust process would show significant sensitivity to these changes, resulting in disproportionately large alterations in the curve's shape for minor input differences.

Such a robustness issue can also be regarded as a sensitivity issue or a non-consistent response of the curve to control point adjustments, where the curve's response to modifications is not consistent across its domain due to the underlying mathematical properties of B-splines. Thus, this issue can be referred to herein as consistency (or sensitivity) of the resulting modified curves to control point adjustments due to computational variations in determining the target point's location.

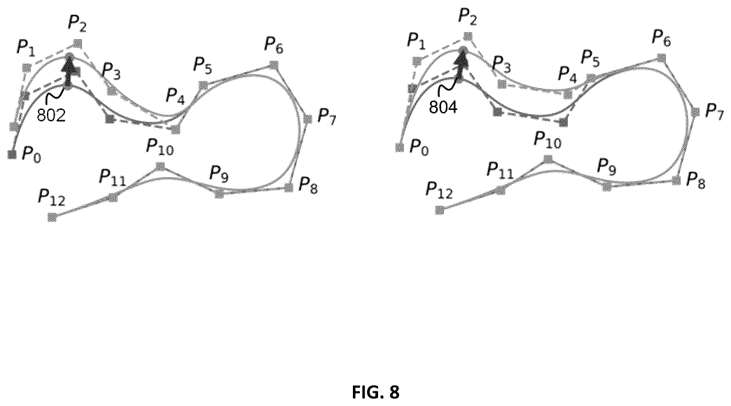

FIG. 7 and FIG. 8 illustrate two examples of such inconsistency of modified curves resulting from variations of the target point's locations in accordance with certain embodiments of the presently disclosed subject matter.

FIG. 7 illustrates an example of a B-spline curve with thirteen control points P₀-P₁₃. A target point 702 is to be moved with a target displacement denoted by the arrow. In the example of FIG. 7, a method of moving a single control point, as mentioned above, is used for the curve modification. Specifically, the control point P₃ is moved in the left illustration to realize the moving of target point 702.

In the right illustration, due to computational variations in determining the target point's location, as explained above, the location 704 of the target point has a slight variation (a slight shift towards the direction of control point P₄), as compared to the location 702 (which may be not visually observable in the illustration due to the minor magnitude of the variation). In such cases, the selected control point to be moved is P₄ for realizing the target displacement. However, due to the change of the selected control point, the resulting modified curve presents a relatively significant difference in shape with respect to the resulting curve in the left illustration, indicating that slight perturbation/variation of the target point's location can induce substantive inconsistencies/discontinuities in the resulting curves.

FIG. 8 illustrates the same B-spline curve as of FIG. 7. A target point 802 is to be moved with a target displacement denoted by the arrow. In the example of FIG. 8, a method of moving multiple control points, as selected in accordance with block 204 described above, is used for the curve modification. Specifically, four control points are selected to realize the target displacement of the target point. In the present example, the four control points will be moved with the same amount of displacement in terms of direction and magnitude.

Specifically, in the left illustration, P₀-P₃ are moved to realize the moving of target point 802. In the right illustration, due to computational variations in determining the target point's location, as explained above, the location 804 of the target point has a slight variation (a slight shift towards right, i.e., the direction of control point P₄), as compared to the location 802. In such cases, the selected control points that impact the movement switch to be P₁-P₄. However, due to the change of the selected control points, the impact of P₀ immediately reduces to zero, and P₄ started to influence the resulting curve. Therefore, the resulting modified curve in the right illustration presents a relatively substantive difference with respect to the resulting curve in the left illustration (e.g., a sudden jump of the curve observable at least at the location of P₀ and P₄), indicating again that slight perturbation/variation of the target point's location can induce substantive inconsistencies/discontinuities in the resulting curves.

For purpose of preserving the geometrical properties of the resulting B-spline curve after the manipulation, such as continuity, smoothness etc., and for maintaining the robustness/consistency of the modification process, certain embodiments of the present disclosure propose a unique way of defining wᵢ, as detailed below.

Specifically, in some embodiments, the proportional relationship (i.e., the proportion wᵢ in above equations (3) and (4)) for a given control point can be defined in a form of a normalized basis function of the given control point, as illustrated below in equation (5):

$${w}_{i} = α {N}_{i , p} \qquad ( 5 )$$

In the above equation, a can be regarded as a normalization coefficient/factor to be applied on the basis function, such that wᵢ can be uniquely constructed as being proportional to the basis function.

In order to derive the value of a, equation (5) can be integrated into equation (4). Via mathematical operations, a can be computed and then integrated back to equation (5) to obtain the following representation of wᵢ in equation (6):

$${w}_{i} = \frac{{N}_{i , p} ( \overline{u} )}{{\sum }_{j = k - p}^{k} {N}_{j , p}^{2} ( \overline{u} )} \qquad ( 6 )$$

Now that the proportional relationship wᵢ is obtained, it can be integrated into equation (3) for deriving the specific displacements of each of the selected control points, which are proportional to the target displacement of the target point according to wᵢ.

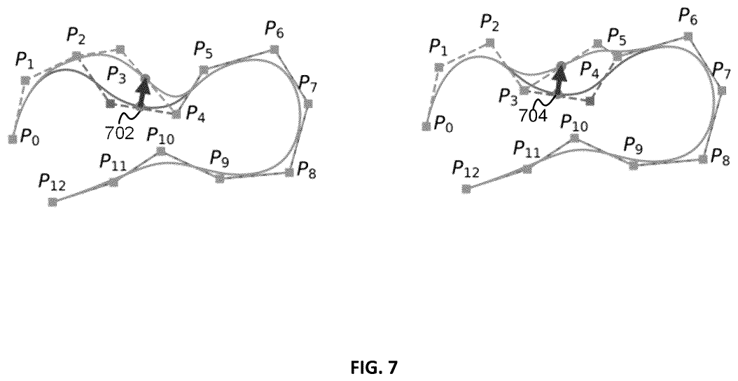

FIG. 6 illustrates an exemplary representation of basis functions and proportional relationships (w₁) derived therefrom in accordance with certain embodiments of the presently disclosed subject matter.

FIG. 6 uses the same graph 404 from FIG. 4 as an example, showing a representation of basis functions of B-spline curve 402 in an x-y coordinate, where the x axis represents the value of parameter/variable u, and the y axis represents the values of the basis functions. N₀-N₉ represent respective basis functions of control points P₀-P₉. Each basis function is represented as a piece-wise polynomial function of the variable/parameter u, representing how a corresponding control point influences the shape of the B-spline curve over a certain range/interval of the variable u domain, referred to as the local control characteristic of a B-spline curve.

Graph 604 illustrates an illustration of proportional relationships (w) between respective displacements of the control points and a target displacement of a target point. Specifically, w₀-w₉ are derived as normalizations of the basis functions N₀-N₉ according to above equation (6).

As shown, as normalized polynomial functions, w₀-w₉ have inherited the smoothness property of the basis functions N₀-N₉. In addition, w₀-w₉ also preserve the local control characteristic of the basis functions. Each of w₀-w₉ is non-zero only over a limited range of the variable domain, in a similar manner as N₀-N₉. As wᵢ represents the proportion between respective displacements of the control points and the target displacement of a target point, such a local control characteristic can ensure that when a control point gradually “loses” control of the curve due to the local control characteristic of its basis function (i.e., when the basis function of the control point gradually reduces to zero), the corresponding displacement of the control point will also be gradually reduced to zero, due to the proportional relationship therebetween. This enables that when the location of the target point on the curve are close/in proximity to locations whose parameter values indicate a switch of selected control points impacting the curve (e.g., as indicated by the values in the knot vector), variations of the target point's location would not cause abrupt deviation/inconsistency (shown as a sudden jump) between the resulting modified curves.

By way of example, w₁ 606 represents the proportion between the displacement of control point P1 and the target displacement: ΔP₁=w₁*ΔC. As shown in graph 604, the influence of w₁ 606 gradually disappears when approaching the parameter value of 0.3, which is in agreement with the influence of control point P₁ over the curve as indicated by the basis function N₁ 606 of P₁. Assume a target point's location is close to the parameter value of 0.3, such as, e.g., 0.29, where the subset of influencing control points includes P₁. Thus, for moving the target point to a target displacement, P₁ would be adjusted by a specific displacement based on the proportion w₁ to the target displacement.

Assume, due to computation variations, the location of the target point presents small variations and it may be computed as 0.3 or 0.31 instead of 0.29, where P₁ already loses impact on the curve, and P₅ just joins the subset of influencing control points. In such cases, different from other modification methods, such as those exemplified in FIGS. 7 and 8, the present solution ensures that the displacement of P₁ naturally and gradually decreases when the location approaches the parameter value of 0.3, and eventually reduces to zero, attributed to w₁ 606 which uniquely correlates with the basis function of P₁ in the proportional relationship. Therefore, even with a switch of control points at the location of 0.3 or 0.31, the displacement of P₁ has already naturally reduced to zero, whereas the displacement of the newly joined control point P₅ starts to increase gradually from zero based on w₅. In such ways, the resulting modified curves will have a smooth transition therebetween (i.e., preserving consistency between the two modified curves), without any abrupt jump or discontinuity.

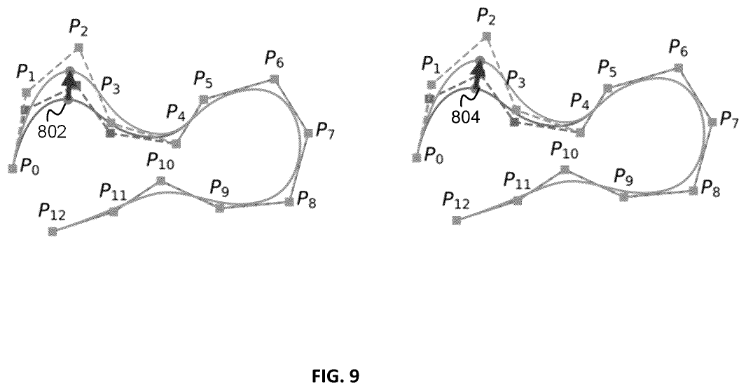

FIG. 9 illustrates an example of consistency of modified curves resulting from variations of the target point's locations in accordance with certain embodiments of the presently disclosed subject matter.

FIG. 9 uses the same example of a B-spline curve with thirteen control points P₀-P₁₂ as illustrated in FIGS. 7 and 8. The same target point 802 is to be moved with a target displacement denoted by the arrow, as shown in the left illustration. As described above, four control points are selected to realize the target displacement of the target point. In the present example, the four control points will be moved with respective displacement based on the proportional relationship with respect to the target displacement as described above.

Specifically, in the left illustration, P₀-P₃ are the influencing control points to be adjusted to realize the moving of target point 802. In the right illustration, due to computational variations in determining the target point's location, as explained above, the location 804 of the target point has a slight variation as compared to the location 802. In such cases, the selected control points that impact the movement switch to be P₁-P₄. Using the proposed methodology, even in cases of switching influencing control points, the impact of P₀ does not have a sudden reduction to zero, as the displacement of P₀ gradually decreases and smoothly reduces to zero when the target location varies from 802 to 804. This is attributed to the proportion w₀ which correlates with the basis function of P₀ in the proportional relationship. Similarly, the impact of P₄ does not have a sudden increase, as the displacement of P₄ gradually increases from zero when the target location varies from 802 to 804. This is attributed to the proportion w₄ correlated with the basis function of P₄ in the proportional relationship. As shown, the two resulting curves in the two illustrations present a smooth transition and consistency therebetween, without any abrupt jump, in contrast to the resulting curves in FIG. 8.

To summarize, FIG. 3 illustrates a generalized flowchart of defining the transition function in accordance with certain embodiments of the presently disclosed subject matter.

As described above, the transition function is uniquely defined so as to enable the consistency of different modified B-spline curves resulting from variations of locations of the target point on the B-spline curve (e.g., avoiding abrupt jump and deviation), in addition to ensuring the resulting modified curve to have a natural appearance/shape with respect to the original B-spline, and preserve the geometric properties such as smoothness, continuity, etc.

To accomplish such a goal, in some embodiments, the transition function can be defined (302) with a first assumption, i.e., to represent, for each given control point of the one or more control points, a respective proportional relationship (wᵢ) between a respective displacement of the given control point and the target displacement (as shown in above equation (3)). The proportional relationship for a given control point can be defined (304) in the form of a normalized basis function of the given control point, which, as described above with reference to FIG. 6 and FIG. 9, can effectively enable the consistency between modified B-spline curves resulting from variations of the location of the target point on the B-spline curve. In other words, this ensures a continuity of the resulting modified B-spline curves when the target point traverses along the B-spline curve (e.g., the resulting modified curves of two target points in proximity to each other on the B-spline curve (such as two on-curve points that are close to each other, but fall into two neighboring spans/intervals) are close/similar to each other, e.g., when assessing them using a similarity/distance metric/threshold.

As described above, the proportional relationship (i.e., the proportion wᵢ in above equations (3) and (4)) for a given control point can be defined in the form of a normalized basis function of the given control point, as illustrated in equation (5), where a is a normalization coefficient/factor applied on the basis function N_{i,p}, such that wᵢ can be constructed as being proportional to the basis function. In some further embodiments, the normalization of the basis function can be represented in alternative manners. By way of example, the basis function can be normalized based on a non-negative real parameter (e.g., q) that is configurable (e.g., by the user) to tune a range of displacements of curve points that are impacted by the moving of the target point. In such cases, the proportion wᵢ can be represented in below equation (7):

$${w}_{i} = α {N}_{i , p}^{q} \qquad ( 7 )$$

In the above equation, q is a power parameter defined by the user which provides an additional freedom to manipulate the curve modification.

When incorporating equation (7) into equations (4) and (5), the following representation of wᵢ can be obtained as shown in equation (8):

$${w}_{i} = \frac{{N}_{i , p}^{q} ( \overline{u} )}{{\sum }_{j = k - p}^{k} {N}_{j , p}^{q + 1} ( \overline{u} )} \qquad ( 8 )$$

Similarly as described above, the proportional relationship wᵢ can be integrated into equation (3) for deriving the specific displacements of each of the selected control points, which are proportional to the target displacement of the target point according to wᵢ.

In some embodiments, the power parameter q can be configured as a strictly positive real number. By way of example, q can be configured in a range of [1, 4]. In cases where q=1, equation (8) is in fact the same as equation (6). In some cases, when q=0, the modified curve may lose its smooth properties (the smooth properties refer to the smooth transition and consistency between different modified B-spline curves resulting from variations of locations of the target point on the B-spline curve), as described above, which is undesired.

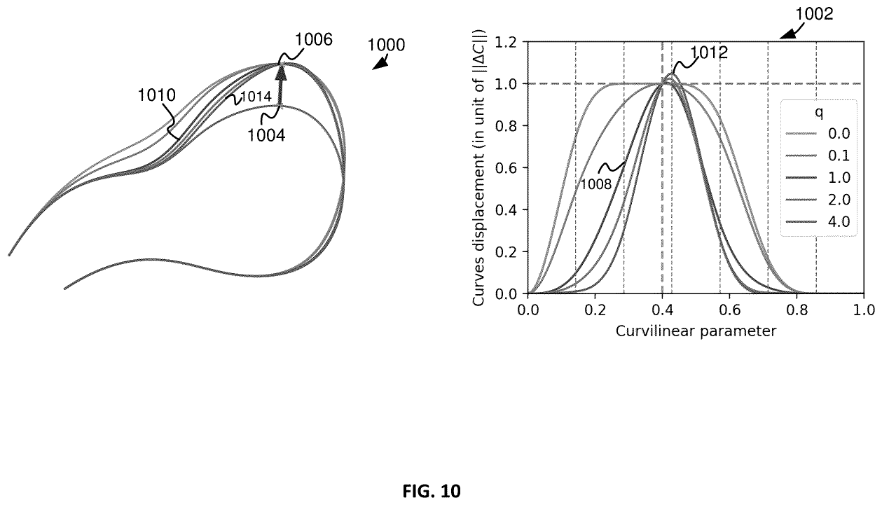

FIG. 10 illustrates an example of curve point displacements of a B-spline curve in cases of different power parameters in accordance with certain embodiments of the presently disclosed subject matter.

Illustration 1000 shows a target point 1004 on an original B-spline curve to be moved to a target location 1006 in accordance with a target displacement. In accordance with the aforementioned methodology, a few control points are selected and moved in accordance with respective displacements, so as to result in a modified curve, where the target point is moved to its target location. As described above, the respective displacements of the selected control points are proportional to the target displacement, and can be derived based on wᵢ, according to, e.g., above equation (8). In such cases, when choosing different power parameter q, the basis functions are normalized differently, and the respective displacements of different control points also vary, resulting in different modified curves as illustrated in 1000.

Graph 1002 shows a plot representation of curve point displacement of the B-spline curve 1004 in an x-y coordinate, where x axis represents curve points at different values of the parameter/variable u, and y axis represents the corresponding displacement magnitudes of the curve points in the unit of ΔC. The various plots in 1002 represent different curve point displacements of the B-spline curve when using different values of the power parameter q, corresponding to the various modified curves as illustrated in 1000.

As shown in 1002, the power parameter q is configured in a range of [0, 4]. By way of example, when q is configured to 1, the plot 1008 represents the specific curve point displacements corresponding to the modified curve 1010 in 1000. When q is configured to 4, the plot 1012 represents the specific curve point displacements corresponding to the modified curve 1014 in 1000. The various modified curves can be regarded as different extensions/variations of manipulation of the B-spline curve, where the curve points on each modified curve have a respective range of displacement from the original curve. For instance, modified curve 1014 has a relatively local adjustment as compared to modified curve 1010 as well as modified curves where q=0 or q=0.1, in the sense that the displacement for a given curve point on curve 1014 is relatively smaller (thus more local) with respect to the displacement of the given curve point in curve 1010, rendering the range of displacements of the curve points that are impacted by such manipulation to be more local/concentrated.

Therefore, in some cases, different configurations of q can be used, e.g., by the user according to the specific application, to tune the range of displacements of curve points that are impacted by the moving of the target point on the curve.

In some cases, when a user specifies a target displacement for a target point on a B-spline curve, it may be the user's intent that the target displacement should be the maximum displacement among all curve points. In other words, there should not be any other curve points that eventually have a larger displacement than the target point. In the example of FIG. 10, when q is configured to be 4, the curve displacement plot 1012 shows that the maximum displacement is achieved at a value of u=0.43, whereas the target point is at a value of u=0.4, as illustrated in graph 1002, which is undesired.

For the purpose of correcting such unwanted maximum displacement shift, certain embodiments of the present disclosure propose to normalize the proportion wᵢ with a correction function, such that the maximum displacement is expected to be always reached at the target point (i.e., the target displacement of the target point is the maximum displacements of all curve points that are moved due to the manipulation).

The target displacement is reached via the parameter a as described above, which is computed such that the on-curve point is moved with the given target displacement. In general, the distance between the two curves (i.e., the original curve C(u) and the modified curve C_{modified} (u)) at each parameter u, as defined by d(u)=∥C(u)−C_{modified}(u)∥, may not be maximal at the parameter value that corresponds to the on-curve point moved.

In order for the maximal distance to be always at the parameter value corresponding to the on-curve point moved, the maximal distance equation (illustrated below as equation (9)) must be satisfied for the control point displacement weight (wᵢ). However, the current form of wᵢ from equation (7) may lack degree of freedom in this regard. Only one degree of freedom is needed to make the maximal distance equation true, for purpose of introducing a factor from each wᵢ linked via one parameter (7).

Bernstein functions can be selected, which are functions with good properties (e.g., polynomial, and convex, etc.) in order to link the p+1 weights, i.e., w₀, . . . , wₚ, via one parameter 7. In the selected particular function (i.e., the Bernstein function), 7 can be a real number lying between 0 and 1. One can solve the equation to obtain the adequate γ values. Because the equation depends on (it), the γ depends also indirectly to the (u).

In accordance with the above, the equation on the weight wᵢ to obtain the maximal displacement on the on-curve point to move is:

$$\sum {N}_{ip}^{′} ( \overline{u} ) {w}_{i} = 0 \qquad ( 9 )$$

where N′ᵢₚ is the derivative of the basis function.

One can chose the form of the weights wᵢ to be:

$${w}_{i} = α \times {N}_{i , p}^{q} ( \overline{u} ) \times {B}_{i} ( γ ) \qquad ( 10 )$$

where Bernstein function Bᵢ(γ) as illustrated below in equation (11) can be used as the correction function:

$${B}_{i} ( γ ) = ( \begin{matrix}p \\ i\end{matrix} ) {{γ}^{i} ( 1 - γ )}^{p - i} \qquad ( 11 )$$

where γ represents a parameter that adjusts the influence of control points.

Injecting the form of the weights into the equation (9) to obtain the maximal displacement at the on-curve point to move gives the equation (12):

$${\sum }_{i = k - p}^{k} {N}_{i , p}^{′} ( \overline{u} ) {N}_{i , p}^{q} ( \overline{u} ) {B}_{i} ( γ ) = 0 \qquad ( 12 )$$

Using the above function allows to tune the influence of the control points in a natural way, with only one scalar parameter (γ).

When solving equation (12), wᵢ can be derived as a normalization of the basis function, e.g., by multiplying the basis function with the correction function, and represented in below equation (13):

$${w}_{i} = \frac{{N}_{i , p}^{q} ( \overline{u} ) {B}_{i} ( γ )}{{\sum }_{j = k - p}^{k} {N}_{j , p}^{q + 1} ( \overline{u} ) {B}_{j} ( γ )} \qquad ( 13 )$$

By using the above proportion wᵢ, the maximum displacement of curve points is expected to be reached at the target point.

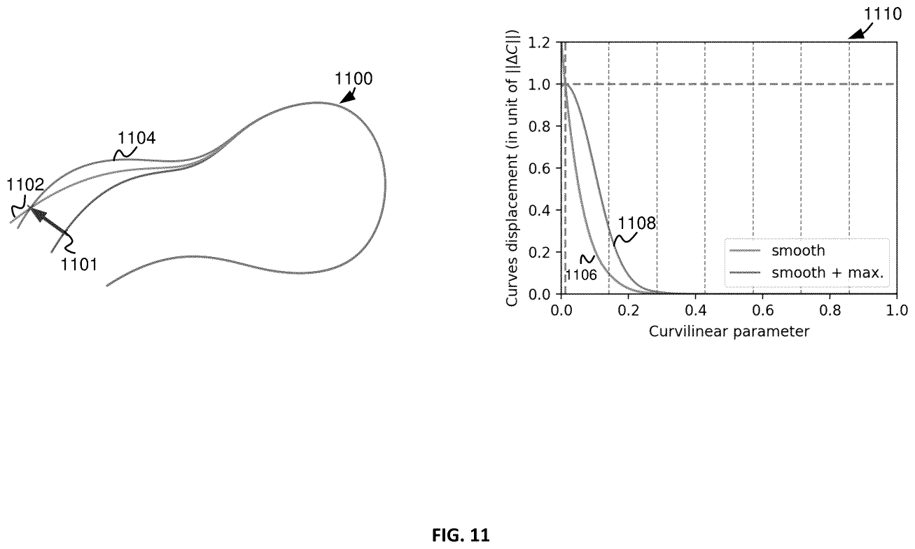

FIG. 11 illustrates an example of curve point displacements of a B-spline curve with or without the normalization by a correction function in accordance with certain embodiments of the presently disclosed subject matter.

Illustration 1100 shows a target point 1101 on an original B-spline curve to be moved to a target location in a modified curve in accordance with a target displacement. As described above, the respective displacements of the selected control points can be derived in accordance with the wᵢ, based on, e.g., above equation (6) or (8) which is without normalization of a correction function, or equation (13) with normalization of a correction function. As shown in 1100, when using an uncorrected wᵢ, the resulting modified curve 1102 is obtained, where the maximum displacement is not at the target point (but rather at the starting point of the curve). When using a corrected wᵢ, the resulting modified curve 1104 is obtained, where the maximum displacement is indeed reached at the target point.

This can also be seen in graph 1110 illustrating a plot representation of curve point displacement of the B-spline curve in an x-y coordinate, where the x axis represents curve points at different values of the parameter/variable u, and the y axis represents the corresponding displacement magnitudes of the curve points in the unit of ΔC. The plot 1106 represents curve point displacements of the B-spline curve without correction, which corresponds to the modified curve 1102, whereas plot 1106 represent curve point displacements with the correction, corresponding to modified curve 1104. As shown, plot 1106 has a peak at u=0, while plot 1108 has a peak at the target point where u=0.05 (as illustrated by the dashed line).

The modification of B-spline curves has wide applications. By way of example, the modified B-spline curve is usable in optical proximity correction (OPC), for purpose of compensating lithography process errors caused during a lithography process (e.g., to manufacture a semiconductor wafer) using the design layout. In such cases, optionally, the original design layout would be modified to include the modified B-spline curve, and the method as described with reference to FIG. 2 can further comprise using the modified design layout comprising the modified B-spline curve in the lithography process so as to compensate such lithography process errors.

By way of another example, the modified B-spline curve, as part of the modified design layout, is usable as at least part of a coarse contour of the curvilinear pattern in the modified design layout. The coarse contour can be used as a reference contour for identifying an actual contour in an examination image of a specimen manufactured using the modified design layout, such as, e.g., in the process of image segmentation in SEM images. The reference contour can be used to be compared with the actual contour for different examination purposes, such as, e.g., obtaining measurements in metrology operations, and/or defect-related operations during runtime examination of the specimen. In such cases, the method as described with reference to FIG. 2 can further comprise using the coarse contour as a reference contour for identifying the actual contour, as well as further examination operations.

It is to be noted that examples illustrated in the present disclosure, such as, e.g., the exemplified B-spline curves, the exemplary basis functions, the specific forms of the transition functions, and specific modification of the curves, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein, is providing a pattern modification system for modifying a curvilinear shape, in particular, a B-spline curve in a design layout of a semiconductor specimen. The proposed solution can preserve the geometrical properties of the resulting B-spline curve after the modification, such as continuity and smoothness, etc., and maintaining the robustness of the modification process, in terms of the consistency/closeness between modified curves resulting from variations of locations of the target point on the B-spline curve.

The proposed solution uses a specifically defined transition function to enable such modification. Specifically, the transition function can be defined to represent a proportional relationship between a respective displacement of each given control point and the target displacement of the target point, where the proportional relationship for a given control point is defined in a form of a normalized basis function of the given control point.

Among further advantages of certain embodiments of the presently disclosed subject matter as described herein, is using the modified B-spline curve in various applications, such as, e.g., in OPC for compensating lithography process errors in a lithography process, or using the modified B-spline curve as part of a reference contour for identifying an actual contour in an examination image acquired for a specimen manufactured using the design layout.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “modifying”, “selecting”, “determining”, “moving”, “defining”, “representing”, “enabling”, “forming”, “using”, “compensating”, “identifying”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the fabrication system, the pattern modification system, and respective parts thereof disclosed in the present application.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, photomasks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution of the images and/or size of an inspection area.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss, can be indicated as a DOI. In some other cases, a defect may be a nuisance (also referred to as “false alarm” defect) which can be disregarded because it has no effect on the functionality of the completed device and does not impact yield.

The term “runtime” used in this specification refers to the on-line fabrication process and/or examination process in the fabrication plant (FAB) where production wafers are fabricated. A setup phase refers to a recipe setup stage prior to its deployment in the runtime/production phase. A runtime process, such as the specimen examination process, has many performance requirements to meet, such as accuracy, throughput (TpT) etc. Therefore, care needs to be taken with regard to which operations should be completed during setup, and which operations should be performed in runtime, in order to meet such strict requirements.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, and extensions thereof, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data).

It is appreciated that, unless specifically stated otherwise, certain features of the presently disclosed subject matter, which are described in the context of separate embodiments, can also be provided in combination in a single embodiment.

Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of modifying a curvilinear pattern in a design layout of a semiconductor specimen, the system comprising a processing circuitry configured to:
obtain a basis spline (B-spline) curve contouring at least part of the curvilinear pattern, and a target displacement for a target point on the B-spline curve, the B-spline curve defined based on a set of control points;
select, from the set of control points, one or more control points to be adjusted based on the location of the target point on the B-spline curve; and
determine one or more displacements of the one or more control points based on a transition function, so as to obtain, upon moving the one or more control points according to the one or more displacements thereof, a modified B-spline curve comprising the target point moved according to the target displacement.

2. The computerized system according to claim 1, wherein the B-spline curve is defined by a curve function represented as a combination of the set of control points multiplied by a set of basis functions respectively associated therewith.

3. The computerized system according to claim 2, wherein a basis function of a given control point is a piece-wise polynomial function of a variable representing a location on the B-spline curve.

4. The computerized system according to claim 2, wherein the one or more control points are selected based on values of the set of basis functions at the location of the target point on the B-spline curve.

5. The computerized system according to claim 1, wherein the transition function is defined to represent, for each given control point of the one or more control points, a respective proportional relationship between a respective displacement of the given control point and the target displacement.

6. The computerized system according to claim 5, wherein the proportional relationship for a given control point is defined in a form of a normalized basis function of the given control point.

7. The computerized system according to claim 6, wherein the basis function is normalized based on a power parameter configurable to tune a range of displacement of curve points that are moved due to modification of the B-spline curve.

8. The computerized system according to claim 6, wherein the basis function is normalized by a correction function such that a maximum displacement of curve points on the B-spline curve is the target displacement of the target point.

9. The computerized system according to claim 1, wherein the transition function is defined to enable consistency of modified B-spline curves resulting from variations of the location of the target point on the B-spline curve.

10. The computerized system according to claim 1, wherein the transition function is defined to enable the modified B-spline curve to preserve geometric properties of continuity and smoothness.

11. The computerized system according to claim 1, wherein the modified B-spline curve forms a part of a modified design layout of the semiconductor specimen, the modified design layout usable in a lithography process for compensating lithography process errors.

12. The computerized system according to claim 1, wherein the modified B-spline curve forms at least part of a coarse contour of the curvilinear pattern in a modified design layout of the semiconductor specimen, the coarse contour usable as a reference contour for identifying an actual contour in an examination image acquired for a specimen manufactured using the modified design layout.

13. A computerized method of modifying a curvilinear pattern in a design layout of a semiconductor specimen, the method comprising:
obtaining a basis spline (B-spline) curve contouring at least part of the curvilinear pattern, and a target displacement for a target point on the B-spline curve, the B-spline curve defined based on a set of control points;
selecting, from the set of control points, one or more control points to be adjusted based on the location of the target point on the B-spline curve; and
determining one or more displacements of the one or more control points based on a transition function, so as to obtain, upon moving the one or more control points according to the one or more displacements thereof, a modified B-spline curve comprising the target point moved according to the target displacement.

14. The computerized method according to claim 13, wherein the transition function is defined to represent, for each given control point of the one or more control points, a respective proportional relationship between a respective displacement of the given control point and the target displacement.

15. The computerized method according to claim 14, wherein the proportional relationship for a given control point is defined in a form of a normalized basis function of the given control point.

16. The computerized method according to claim 13, wherein the transition function is defined to enable consistency of modified B-spline curves resulting from variations of the location of the target point on the B-spline curve.

17. The computerized method according to claim 13, wherein the transition function enables the modified B-spline curve to preserve geometric properties of continuity and smoothness.

18. The computerized method according to claim 13, wherein the modified B-spline curve forms a part of a modified design layout of the semiconductor specimen, the modified design layout usable in a lithography process for compensating lithography process errors.

19. The computerized system according to claim 13, wherein the modified B-spline curve forms at least part of a coarse contour of the curvilinear pattern in a modified design layout of the semiconductor specimen, the coarse contour usable as a reference contour for identifying an actual contour in an examination image acquired for a specimen manufactured using the modified design layout.

20. A non-transitory computer readable storage medium tangibly embodying a program of instructions that, when executed by a computer, cause the computer to perform a method of modifying a curvilinear pattern in a design layout of a semiconductor specimen, the method comprising:
obtaining a basis spline (B-spline) curve contouring at least part of the curvilinear pattern, and a target displacement for a target point on the B-spline curve, the B-spline curve defined based on a set of control points;
selecting, from the set of control points, one or more control points to be adjusted based on the location of the target point on the B-spline curve; and
determining one or more displacements of the one or more control points based on a transition function, so as to obtain, upon moving the one or more control points according to the one or more displacements thereof, a modified B-spline curve comprising the target point moved according to the target displacement.
